(19) United States
(12) Patent Application Publication
(10) Pub. No.: US 2025/0124703 A1
(43) Pub. Date: Apr. 17, 2025

(54) ADAPTIVE RECOGNITION USE HISTORY

(71) Applicant: BrightAI Corporation, San Francsico, CA (US)

(72) Inventors: Robert PARKER, Hillsborough, CA (US); Haidong WANG, Clyde Hill, WA (US); Min YANG, Redwood City, CA (US); Barry Christian ANDERSEN, Brooklyn Park, MN (US); Albert Stephen CARR, III, Merritt Island, FL (US); Samuel Roger CARLTON, Ostego, MN (US); Kevin Michael SPINAR, Shoreview, MN (US); Kevin VANDEN BERGE, Hudsonville, MI (US)

(21) Appl. No.: 18/917,476

(22) Filed: Oct. 16, 2024

Related U.S. Application Data
(60) Provisional application No. 63/591,034, filed on Oct. 17, 2023.

(51) Int. Cl. G06V 10/82; G06T 7/13; G06T 7/136

(52) U.S. Cl. CPC G06V 10/82; G06T 7/13; G06T 7/136

(57) ABSTRACT

Methods, devices, or systems that may allow for remote monitoring of a capture area or the automatic inspection of a capture area, such as an adhesive board, among other things. In one aspect, the disclosed subject matter includes receiving an image of a capture area, generating current detection boxes associated with objects (e.g., pests) by performing object detection on the image, determining output boxes by comparing the current detection boxes with historical detection boxes, generating the output boxes, and transmitting an object count based on the output boxes.

### CROSS-REFERENCE TO RELATED APPLICATION

This application claims the benefit of U.S. Provisional Patent Application No. 63/591,034, filed on Oct. 17, 2023, entitled “Connected Fly Light,” the contents of which are hereby incorporated by reference herein.

### TECHNICAL FIELD

The technical field generally relates to machine learning and more specifically relates to detection of objects.

### BACKGROUND

Cameras or other sensors may capture a designated capture area. In an example, a camera may capture an area associated with a capture apparatus, such as a pest-control capture apparatus. Industries may utilize pest-control capture apparatuses, such as fly lights, glue traps, live animal traps, snap traps, electric insect zappers, or pheromone traps.

Fly lights may be used to capture flies and monitor insect populations in a given space. These fly lights may lure flies in, such that the flies may subsequently be trapped on an adhesive board to be then manually inspected and counted by a pest control technician. Conventionally, a pest control technician may be required to visit the space periodically and count the number of flies captured on the adhesive board. Manual inspection of any capture area, whether associated with pests or other objects, may be time-consuming, labor-intensive, and prone to human error.

This background information is provided to reveal information believed by the applicant to be of possible relevance to the present invention. No admission is necessarily intended, nor should be construed, that any of the preceding information constitutes prior art against the present invention.

### SUMMARY

The process of in-person manually counting objects at a singular moment in time may be inefficient and prone to errors. Manual inspections often require accessing capture area (e.g., fly lights or adhesive boards) in hard-to-reach places, which may require the use of ladders and potentially shutting down customer sites during these inspections. Additionally, there may be a delayed response to contamination, as a technician may not promptly address sudden increases in populations. A technician will likely miss activity that occurs during the period between manual inspections.

Technicians in-person manual counting or object detection algorithms may mistakenly interpret dust specks or other debris as insects when they overlap with background grid lines. Additionally, structural elements on or approximate to the capture device, such as struts, edges, or fasteners, may partially obscure captured insects, leading to undercounting. Variations in lighting conditions and shadows can further complicate accurate insect detection and counting.

Disclosed herein are methods, devices, or systems that allow for remote monitoring of a capture apparatus or the automatic inspection of a capture apparatus, such as an adhesive board, among other things. In one aspect, the disclosed subject matter includes receiving an image of a capture area, generating current detection boxes associated with objects by performing object detection on the image, determining output boxes by comparing the current detection boxes with historical detection boxes, generating the output boxes, and transmitting a object count based on the output boxes. The method may include generating output boxes equivalent to the number of current detection boxes when that number exceeds the number of historical tracking boxes, or generating output boxes equal to the sum of current detection boxes and additional boxes when the number of current boxes is less than the number of historical tracking boxes. Additionally, the method may involve applying different processing techniques to different regions of the capture area based on historical object distribution patterns, and displaying visualizations of object count trends over time using output boxes from multiple images. This approach may enable accurate and consistent automated object counting by leveraging historical data to handle detection challenges and provide insights into object population dynamics.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1A is an example system associated with the disclosed subject matter;

FIG. 1B is an example system that includes a cloud platform associated with the disclosed subject matter;

FIG. 2 illustrates an example wide-angle image;

FIG. 3 illustrates an example flattened image version of the wide-angle image;

FIG. 4 illustrates an example segmentation of imagery;

FIG. 5 illustrates an example implementation of object counting;

FIG. 6 is an example method for obtaining or processing object-related information;

FIG. 7 illustrates an example method for detecting and counting objects in images associated with a capture area.

FIG. 8 illustrates an example method for adaptive object detection and counting.

FIG. 9 is an example block diagram representing a general-purpose computer system in which aspects of the methods or systems disclosed herein or portions thereof may be incorporated.

### DETAILED DESCRIPTION

Accurately counting specific insect types on adhesive boards or other capture areas present several challenges. In an example associated with insects, the captured insects may vary in size, orientation, or degree of overlap. Debris or non-target insects may be present, complicating the identification or counting process. Some approaches lack the ability to reliably differentiate between object classes or handle complex foregrounds or backgrounds. While some automated pest detection systems have been developed, they often lack the ability to incorporate historical data to improve accuracy and adapt to changing pest patterns over time. This limitation can lead to inconsistent pest counts and reduced reliability in monitoring pest populations, especially in environments with varying lighting conditions or temporary occlusions. There is a need for more robust and flexible artificial intelligence (AI)-powered methods or systems that may process object sets across diverse image contexts.

The disclosed subject matter may provide and adaptive object (e.g., pest) detection and counting system that utilizes image processing techniques and historical data analysis to provide accurate, real-time pest monitoring. The system may capture images of capture areas, processes these images to detect and count objects, and may compare current detections with historical data to improve accuracy and track object population trends over time. By incorporating historical data through the use of tracking boxes and selectively adding boxes from previous detections, the system may provide more stable object counts even in challenging detection environments. Note a capture area as disclosed herein may be any physical area or area designated digitally to be of significance for analysis. The capture area may be captured by a sensor such as a camera.

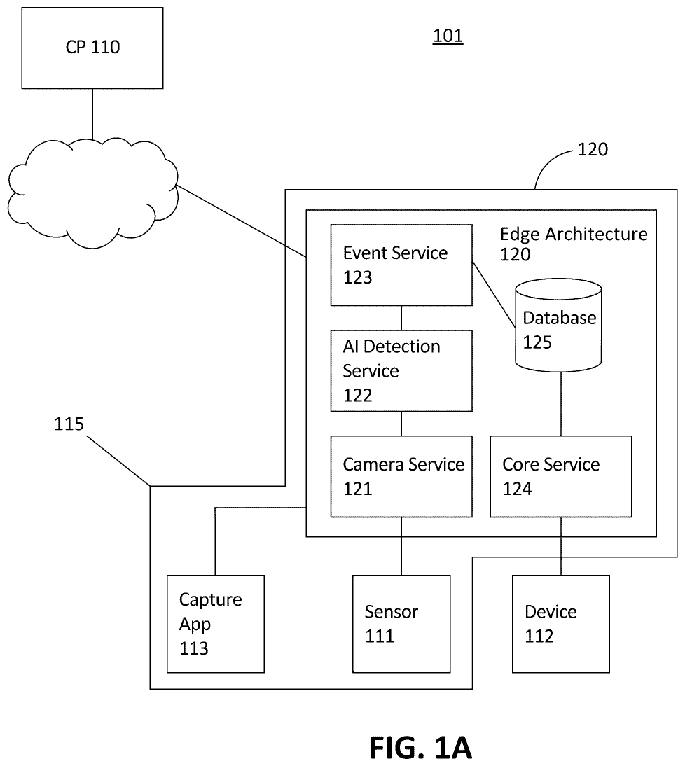

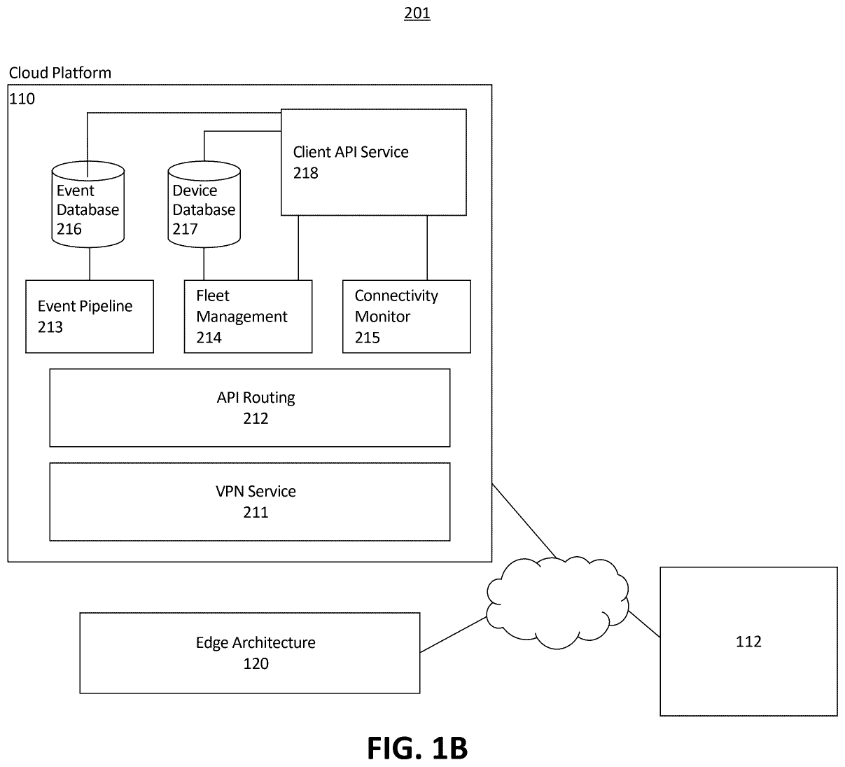

FIG. 1A is an exemplary system 101 associated with a connected pest-control apparatus 115. System 101 may include cloud platform (CP) 110, edge architecture 120, sensor 111 (e.g., camera or another sensor), device 112 (e.g., a mobile device or computer), or pest-control capture apparatus 113 (e.g., fly light), which may be communicatively connected with each other. Connected pest-control apparatus 115 (e.g., connected fly light) as referred to herein may include the following components: pest-control capture apparatus 113, sensor 111, and one or more components of edge architecture 120. Edge architecture 120 may handle tasks such as video frame processing from sensor 111, artificial intelligence-driven pest detection and metrics, or connectivity and configuration management, among other things. It is contemplated that the functions disclosed herein may be executed in one device or distributed over multiple devices.

CP 110 may be one or more devices that handle communications or administration of a network of connected pest-control apparatuses 115 (e.g., fly lights), navigate between application programing interfaces (APIs) for client access to pest-related information (e.g., fly light performance), receive pest detection events, process pest detection events, or store pest detection events, among other things. CP 110 is described in more detail in FIG. 1B.

Sensor 111 may collect video footage of the strategically positioned pest-control capture apparatus 113, such as an adhesive board, that collects pests (e.g., flies or rodents). Sensor service 121 may manage the acquisition of video frames from sensor 111, which may include camera calibration to ensure optimal image capture, periodic capture of video frames at pre-defined intervals, or the storage of video frames in a shared database (e.g., database 125) for later artificial intelligence processing, which may be executed by AI detection service 122.

Edge architecture 120 may include sensor service 121, artificial intelligence (AI) detection service 122, event service 123, core service 124, or database 125. AI detection service 122 may be responsible for the following: 1) hardware-accelerated image decoding for efficient video retrieval; 2) remapping of a wide angle (e.g., fish-eye image to a flattened image for better pest recognition); 3) real-time AI model inference for pest counting or size classification, or 4) post-processing of detection result or storing results in a shared database (e.g., database 125).

Event service 123 may generate event related information, such as image-based event information, based on the pest detection results. In an example, each event may be associated with a high-definition image. Each image-based event may have associated AI detection metadata, which may include pest location, bounding box coordinates, confidence scores, or size classification. Such events may be uploaded to CP 110, as described in further detail in the description of FIG. 1B, for future analysis, alerting, or notification.

Core services 124 may include multiple applications that act as a system for tasks such as onboarding, configuration, connectivity, software updates, or overall management of a connected pest-control apparatus 115. Core services 124 may serve to communicate with the other connected pest-control apparatus 115 in their given network. Core services 124 may utilize Bluetooth connectivity to communicate with device 112 and may communicate with CP 110. Onboarding may be the task of setting up a new connected pest-control apparatus 115 and connecting to CP 110. To perform initial onboarding of the connected pest-control apparatus 115, a mobile app running on device 112 may connect to the connected pest-control apparatus 115 via a Bluetooth interface, allowing a user to perform onboarding functions such as configuring network settings to connect devices associated with the connected pest-control apparatus 115 to the internet or to download software updates.

Database 125 may serve to store pest-related information as collected from devices associated with connected pest-control apparatus 115.

Device 112 may be a mobile phone, laptop, or other apparatus. Device 112 may interact with core services 124 for administrative purposes, which may include onboarding, configuration, connectivity, software updates, or general management of the network of connected pest-control apparatuses 115.

FIG. 1B is an exemplary system 201 that may include cloud platform 110 associated with a connected pest-control apparatus 115. Illustrated in FIG. 1B is a representation of the cloud architecture that may connect the network of connected pest-control apparatuses 115 or organize the pest-related characteristics collected by connected pest-control apparatus 115 in a portal API for web or mobile management. System 201 of FIG. 1B may include edge architecture 120, CP 110, or device, which may be communicatively connected with each other.

The devices or functions of edge architecture 120 may monitor pest detection or capture pest-related metrics through the use of artificial intelligence or manage connectivity and configuration between the connected pest-control apparatuses 115, among other things. Edge architecture 120 is described in more detail herein.

CP 110 may include virtual private network (VPN) service 211, API routing 212, event pipeline 213, fleet management system 214, connectivity monitor 215, event database 216, device database 217, or client API service 218 (e.g., client API routing). It is contemplated that the functions disclosed herein may be executed in one or more devices.

VPN service 211 may handle the network communications for the network of connected pest-control apparatuses 115 through secure or encrypted VPN tunnels.

API routing 212 may be responsible for routing API requests originating from connected pest-control apparatuses 115. Connected pest-control apparatus 115 or other associated devices may make requests based on pest detection, connectivity issues, or fleet management-related queries, among other things.

Event pipeline 213 may manage the process of ingesting, routing, processing, or storing pest detection events. The product of event pipeline 213 may be directed toward client API service 218 to be used in real-time analytics for user consumption.

Fleet management system 214 may include services responsible for the management of the connected pest-control apparatuses 115. An interface may be provided for these services for performing administrative tasks or accessing the direct network for real time changes. Administrative tasks may include device onboarding or configuration changes like naming and location updates. Fleet management system 214 may provide for direct network access for near real-time changes, such as data upload intervals or monitoring real-time status; for example, resource usage of the single-board computer (SBC) or Wi-Fi metrics. Real-time changes may include altering the time between data uploads and monitoring the real-time status of the data.

Connectivity monitor 215 may monitor the network health of the connected pest-control apparatuses 115 or provide an interface for accessing the connectivity status of connected pest-control apparatuses 115.

The event database 216 may serve as an intermediary to store product of the event pipeline 213, or other information.

The device database 217 may serve as an intermediary to store product of the fleet management system 214, or other information.

The client API service 218 may serve as an interface for management applications or third-party integration APIs. The client API service 218 may communicate with device 112 to allow for access to pest count data, access to adhesive board images, check connectivity status, or customize settings and alerts associated with connected pest-control apparatus 115. Users may utilize this management application to gain real-time insights into the adhesive board environment. From this application, users may access trend analysis of datasets produced by the client API service 218 or generate reports of the data as needed.

In an example scenario, data associated with pest control capture apparatus 113 may be collected via sensor 111 and the collected data may be managed by sensor service 121. Then, the data (e.g., video footage, still picture, or infrared image) may be processed via deep learning-based object detection algorithm, e.g., using AI detection service 122, which may result in AI detection metadata. Event service 123 may combine images from the video footage with the AI detection metadata to create image-based events based on the results of the object detection algorithm. Those image-based events may then be uploaded to CP 110, for future analysis, alerting, or notification. Event pipeline 213 may receive, route, process, or store the data (e.g., image-based events information, snaps of video footage, or AI detection metadata). The event pipeline 213 may feed the results of its analysis to client API service 218. CP 110 may be used for administrative purposes, such as checking the strength of the network connecting connected pest-control apparatuses 115 or the status of an individual connected pest-control apparatus 115.

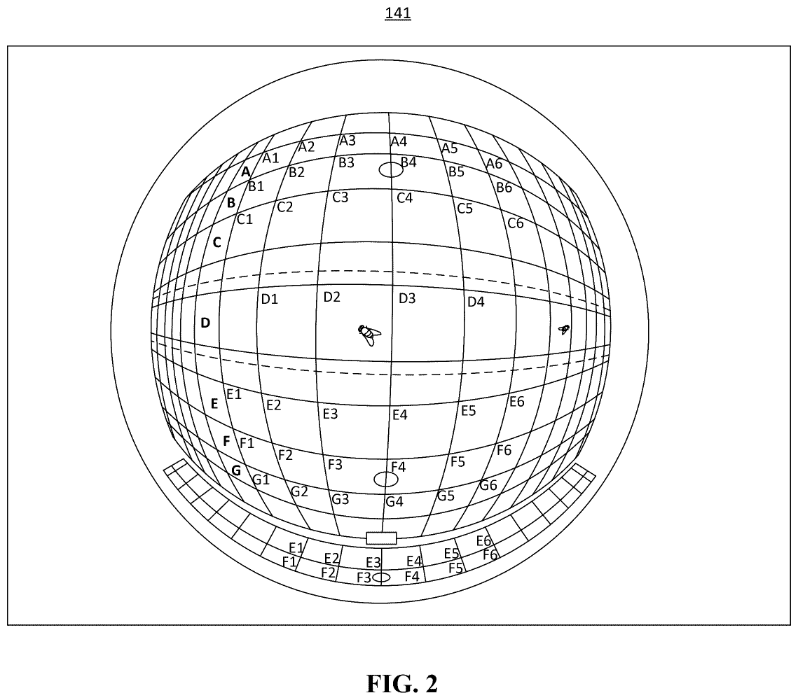

FIG. 2 illustrates an exemplary wide-angle image, which may be on a live image from sensor 111. Sensor 111 may be wide-angled and may be optimized or positioned by sensor service 121 to capture video footage of the adhesive board. An object detection algorithm associated with AI detection service 122 may be used to highlight the pests in the image.

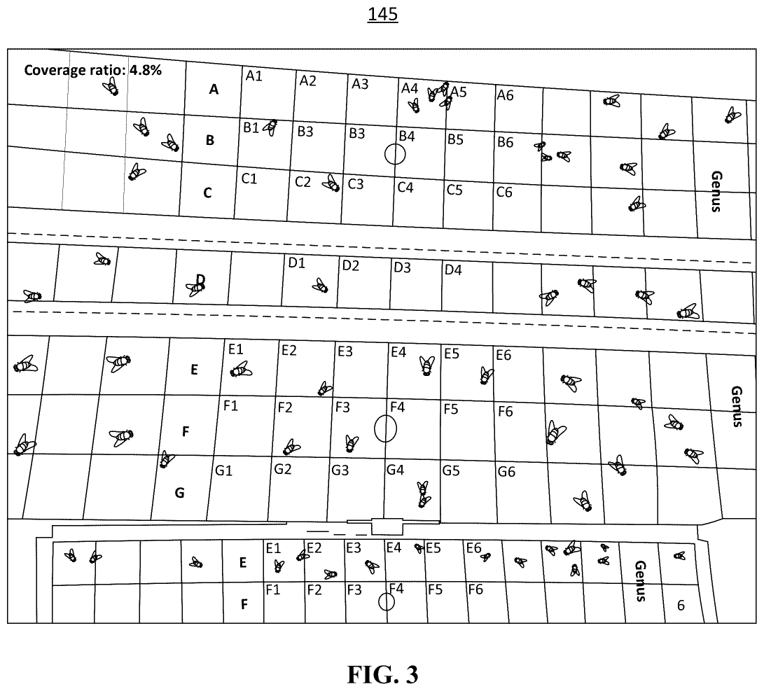

FIG. 3 is a flattened image version of the wide-angle image illustrated in FIG. 2. Positioned flat, the image may exhibit distortions, which may require processing to realign the image to a coherent physical plane. The flattened image as depicted in FIG. 3 may help in the use of enhanced feature detection of pests.

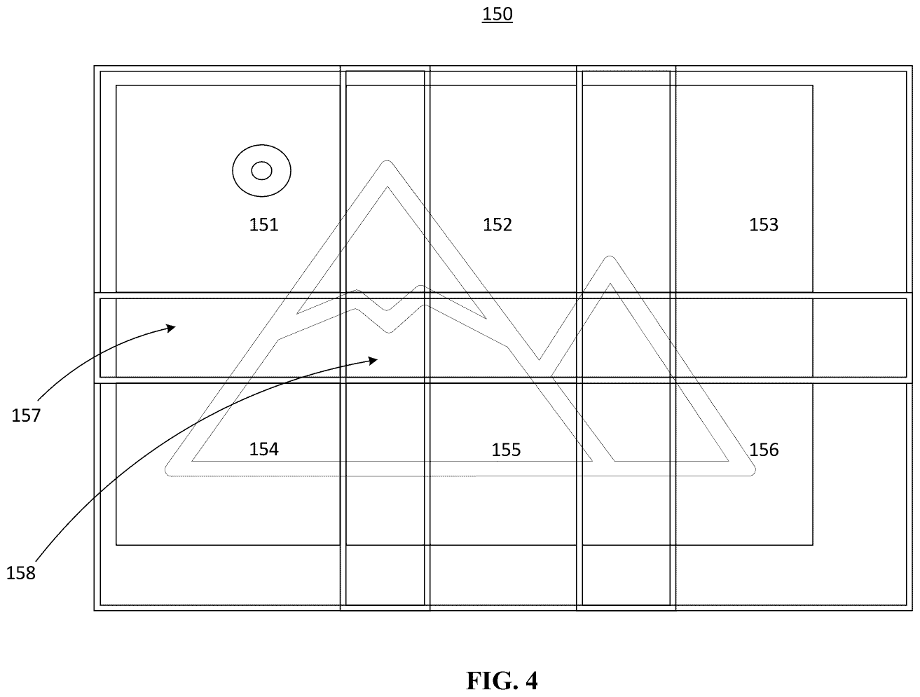

FIG. 4 illustrates an exemplary system for image analysis. In an example, the object detection model may use raw imagery, as depicted in FIG. 3, to be segmented into distinct blocks, e.g., 6 distinct blocks as illustrated in FIG. 4. Upon segmentation, each block may undergo individual object detection, after which the algorithm may consolidate each block's count for a final tally of pests captured on the adhesive board. The six distinct blocks share some overlap, which may ensure that the pests placed in two or more blocks be considered in the calculation.

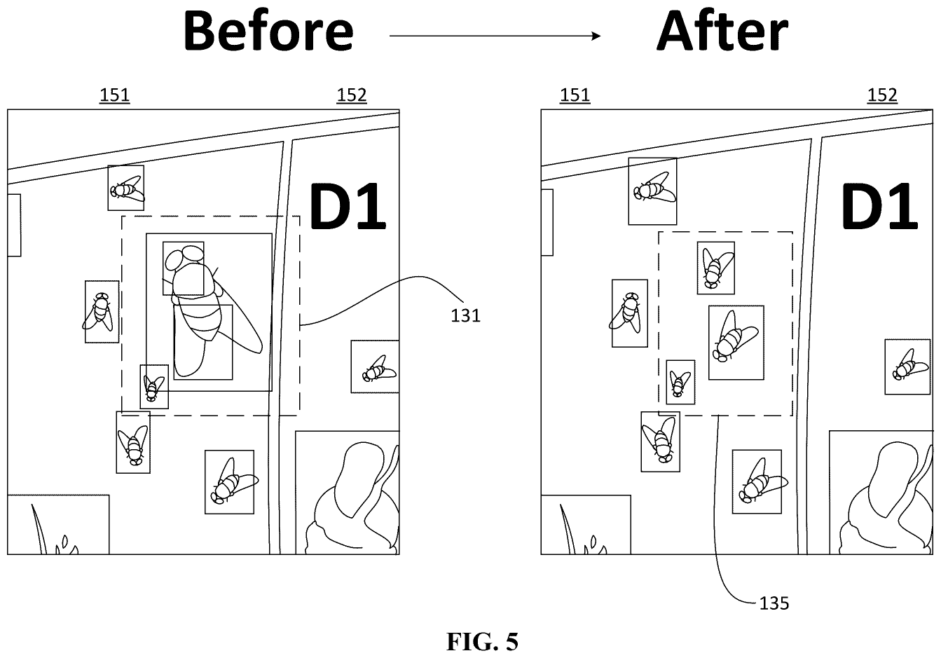

FIG. 5 illustrates an exemplary object detection that considers pest size or pest classification. Beyond mere enumeration, the disclosed subject matter offers size categorization for each detected pest. The system may measure the bounding box dimensions of detected entities (e.g., bounding box 131). To counteract potential image distortions stemming from wide-angle capture devices, the system may employ coordinate-based transformations restoring the bounding box to its true dimension (e.g., multiple bounding boxes as shown in bounding box 135). Size classifications may be ascertained from these rectified bounding boxes. Using these box dimensions also may allow for a better gauge of the comprehensive area of the adhesive board.

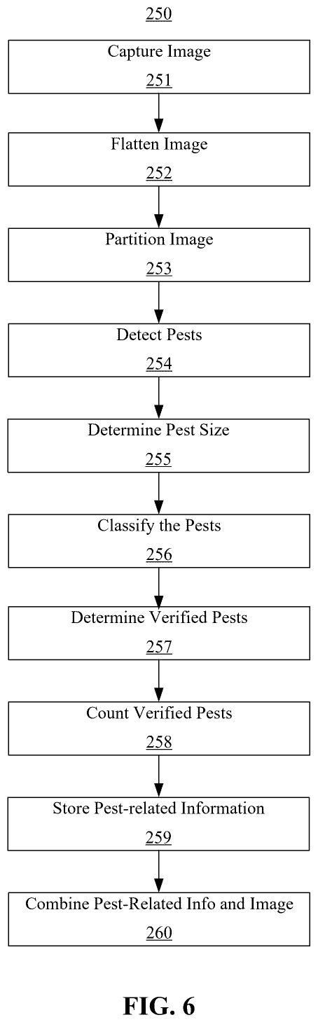

FIG. 6 illustrates an exemplary method 250 for collecting pest-related information from a video-capturing device. Such information may be transformed into usable data on a user portal.

At block 251, sensor 111 may capture image 141 of pest control capture apparatus 113 (e.g., adhesive board). Image 41 may be wide-angle image 141.

At block 252, image 141 may be altered to be flattened image 145. Flattened image 145 may further processed to remove any distortions.

At block 253, flattened image 145 may be processed by an object detection model associated with AI detection service 122. The object detection model associated with AI detection service 122 may partition flattened image 145 (e.g., FIG. 3) into a plurality of distinct segments (e.g., segment 151 through segment 156 in image 150 of FIG. 4). Each segment may overlap with one or more segments. For example, segment 151 may overlap with segment 154 to create overlap 157. In another example, segment 151, segment 152, segment 154, and segment 155 may overlap to create overlap 158.

At block 254, one or more pests are detected in each segment, such as segment 151 through segment 156.

At block 255, determine size of a first detected pest. For each individual segment of flattened image 145, the model may consider pest size or pest classification as depicted in FIG. 5 or historical data from prior image to assess pest routes and prevent overcalculation.

At block 256, classify the first detected pest (e.g., fly, ant, etc.). At block 257, determine, based on a comparison of historical information of a pest classification and the determined size (at block 255) and classification at block 256, a number of verified pests. In an example, a verified pest may be determined to have threshold confidence level.

At block 258, upon analysis of an individual segment (e.g., segment 151), a count may be tallied of the verified pests captured with pest-control capture apparatus 113 at segment 151.

At block 259, store the pest-related information that comprises the count of pests, the classification of pests, or the size of the pest, among other things.

At block 260, the pest-related information (e.g., the number of flies on an adhesive board), may be combined with snippets within the image to be image-based events that are uploaded to CP 110. In CP 110, the image-based events may be ingested, routed, processed, and analyzed within the event pipeline 213. The analysis of such image-based events of method 250 may be mapped for use and consideration in a portal accessible to users. Method 250 may be performed by computing equipment including mobile devices (e.g., tablet computers), servers, or any other device that can execute computing functions.

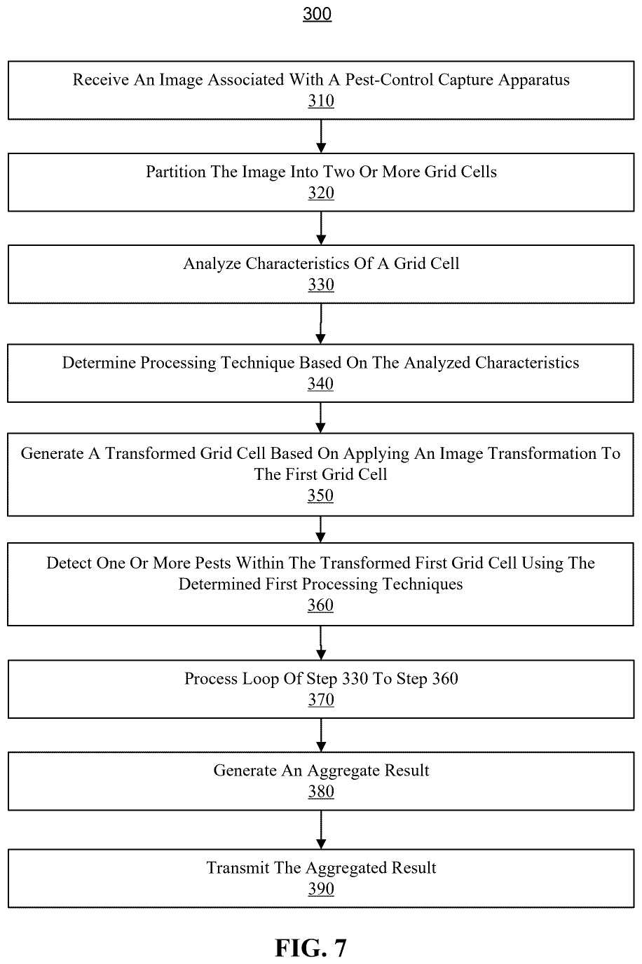

FIG. 7 illustrates method 300 for detecting and counting pests using partitioned image processing. Method 300 may leverage the capabilities of connected pest-control apparatus 115 to provide efficient pest detection and counting in various environmental conditions.

At step 310, an image associated with pest-control capture apparatus 113 may be received. Step 310 may be triggered automatically at predetermined intervals, in response to detected movement, or the like. The captured image may be a color or grayscale image, depending on the specific requirements of a pest detection algorithms and characteristics of target pests.

At step 320, when the image is received, the image may be partitioned into a grid cells (e.g., segment 151 through segment 156). This partitioning may allow for localized processing and optimization of pest detection algorithms. Specific image processing techniques (e.g., adjustments) to individual grid cells (e.g., localized regions) of the image may be applied, rather than applying uniform transformations to the entire image. The size and shape of the grid cells may be predetermined or dynamically adjusted based on the image content. Dynamic grid sizing may be employed to optimize the partitioning based on pest distribution patterns or image characteristics. For example, areas with high pest density or complex backgrounds may be divided into smaller cells for more detailed analysis, while areas with low pest activity may use larger cells to improve processing efficiency.

At step 330, for each grid cell, the processing unit 130 analyzes the characteristics of the cell. This analysis may include brightness and contrast assessment, background complexity evaluation, texture analysis, color distribution analysis (for color images), edge detection and feature extraction, and noise level estimation. In an example, many pest capture surfaces may have a distinct texture (e.g., adhesive traps might have a glossy or grainy appearance), while pests often have different textural characteristics. In addition, different types of pests may have distinct textural features (e.g., smooth vs. hairy bodies). Texture analysis may be performed with regard to each grid cell by calculating statistical measures of pixel intensity variations. For instance, the gray level co-occurrence matrix (GLCM) may be computed and features may be derived, such as contrast, homogeneity, or entropy. In a grid cell containing a smooth plastic surface with several rough-bodied flies, the texture analysis may reveal areas of low contrast and high homogeneity (the plastic surface) interspersed with small regions of high contrast or low homogeneity (the flies). This textural information may then be used to aid in pest detection and differentiation from a background associated with the pest-control capture apparatus 113. The results of this analysis are used to inform the selection of appropriate processing techniques and image transformations for each individual cell.

At step 340, based on the analyzed characteristics of each cell, the most appropriate processing technique and heuristics are determined. This step 340 may allow for an adaptable approach to the specific content of each cell, which may improve overall accuracy or efficiency. Examples of processing techniques that may be selected include threshold-based segmentation for cells with a threshold (e.g., high) contrast, edge-based detection for cells with clear pest outlines, texture-based analysis for cells with complex backgrounds, color-based segmentation for cells where pests have distinct colors, or machine learning-based detection for cells with ambiguous content. The selection process may utilize a decision tree, rule-based system, or machine learning model trained on diverse pest images and capture conditions.

At step 350, image transformation (which may be local image transformation) may be applied, as needed, to each cell. The image transformation may be designed to enhance the image quality, which may facilitate more accurate pest detection. Image transformation may include contrast enhancement to improve pest visibility, noise reduction to remove artifacts that could be mistaken for pests, sharpening to enhance pest contours, color correction to normalize pest appearance across different lighting conditions, or background subtraction to isolate pests from complex backgrounds. The specific image transformations applied to each cell may be determined based on the cell characteristics or the selected processing techniques. This localized approach may allow for optimized image enhancement without affecting other areas of the image that may not require the same transformations.

At step 360, with the transformed cell images, pests may be detected and counted within each grid cell. A variety of algorithms may be employed depending on the selected processing techniques. Approaches may include contour detection and analysis, blob detection algorithms, template matching with known pest shapes, convolutional neural networks trained on pest images, or feature-based classification using support vector machines or random forests. Multiple detection methods may be applied to each cell and use ensemble techniques to combine the results, which may improve overall accuracy. For cells with complex pest distributions or overlapping pests, iterative approaches or advanced segmentation techniques may be employed to separate individual pests. During this step 360, detected objects may be classified as pests or non-pests based on predefined criteria or learned features. This classification may help filter out false positives caused by debris or artifacts in the capture area.

Steps 330 through 360 may be repeated for each cell in the partitioned image at step 370. This loop ensures that all areas of the capture image are analyzed using the most appropriate techniques for their specific characteristics. After processing the grid cells, the system aggregates the pest detection and counting results from each cell at step 380. This aggregation step involves summing the total pest count (e.g., number of pests) across all cells, generating a pest distribution map for the entire capture area, identifying high-density areas or patterns in pest distribution, and calculating confidence levels for the detection results. The aggregation process may also involve resolving conflicts or ambiguities between adjacent cells, such as pests that span cell boundaries or inconsistent detection results in neighboring cells.

Once all cells have been processed and the results aggregated, the system outputs the final results at step 390. This output may include the total pest count, total pest count by type of pest, pest distribution map, confidence levels or uncertainty estimates, highlighted areas of high pest density, or comparison with previous capture results (if available). The results may be based on type of pests. The results may be displayed on the user interface of device 112 and may also be stored in memory 140 for historical analysis or transmitted to remote systems via the communication module 160.

At step 390, additional features (e.g. techniques) may be incorporated such as temporal analysis, multi-scale processing, adaptive learning, random parameter testing, or parallel processing. Temporal analysis may allow for new pest activity for the system to identify, track pest movement over time, or detect changes in background or lighting conditions. Multi-scale processing may help in detecting pests of varying sizes, handling areas in which pests cross cell boundaries, or identifying larger patterns in pest distribution. Adaptive learning may adjust processing parameters based on historical results and user feedback. Random parameter testing may be employed for cells with complex pest distributions or challenging detection conditions. Parallel processing techniques may be used to improve efficiency by processing different cells or groups of cells simultaneously.

By employing comprehensive and adaptive method, connected pest control apparatus 115 may provide pest detection and counting results across a wide range of environmental conditions and pest types. The partitioned image processing approach, combined with localized image transformation or multi-scale analysis, may enable handling of challenges of non-uniform images or complex pest distributions of real-world pest control scenarios.

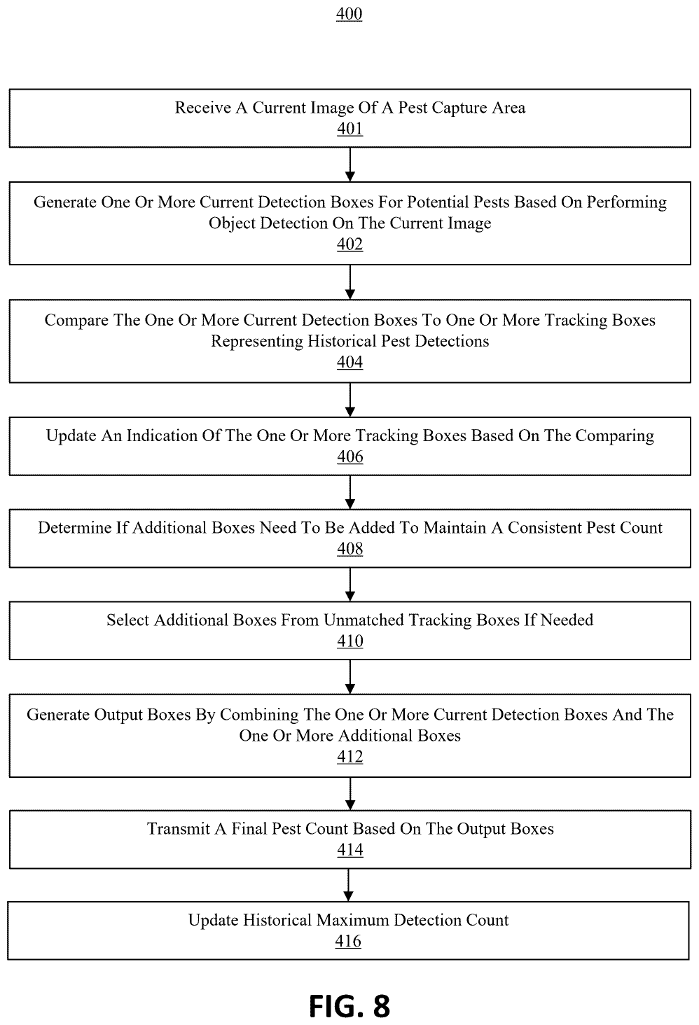

FIG. 8 illustrates an exemplary method 400 for adaptive pest detection and counting as disclosed herein. At step 401, a current image of a pest capture area and historical pest detection data may be received.

At step 402, object detection may be performed on the current image to generate one or more detection boxes for potential pests. The object detection may be performed using a convolutional neural network or other suitable algorithm trained on pest image data. These are the bounding boxes generated by the object detection algorithm for the current image. Each detected object in the image has an associated detection box. Each detection box may represent a bounding region around a detected pest in the current image.

At step 404, the one or more detection boxes may be compared to tracking boxes representing historical pest detections. This comparison may involve matching current detections with historical detection boxes based on spatial overlap, appearance similarity, or other relevant criteria. The tracking boxes may represent a set of unique detection boxes determined based on some or all previous input images, serving as a historical record of pest detections over time.

At step 406, the tracking boxes may be updated based on the comparison. This update may involve adding new detection boxes that do not match any existing tracking boxes and removing tracking boxes that have not been matched for a predetermined number of images. This step may help maintain an up-to-date historical record of pest detections.

At step 408, a determination may be made if additional boxes need to be added to maintain a consistent pest count. This determination may involve calculating the difference between the current detection count and a historical maximum detection count. The historical maximum detection count represents the maximum number of detection boxes calculated from a single input image over time.

At step 410, if additional boxes are needed, they may be selected from unmatched tracking boxes. These additional boxes are likely to represent pests that were detected in previous images but missed in the current detection. The selection of additional boxes may prioritize tracking boxes with threshold (e.g., high) stability scores, indicating consistent detection over multiple previous images. For the matching process that produces the unmatched tracking boxes, there may be a comparison in which the current detection boxes are on the image with where the historical tracking boxes are on the image. Essentially comparing pixel locations of the bounding boxes with some margin of error added. If there is a historical tracking box where there is no detection box, then it may be added to the set of unmatched tracking boxes.

At step 412, output boxes may be generated by combining current detection boxes and selected additional boxes. These output boxes represent the final set of pest detections for the current image, incorporating consideration of current data associated with the current image and historical data associated with one or more historical images. The output boxes are the final, resulting set of output boxes presented. If the number of detection boxes is greater than or equal to the historical maximum of detection boxes (may be referred to herein as historical detection boxes or historical tracking boxes), then the output boxes are the detection boxes. If the number of detection boxes is less than the historical maximum, then the output boxes are the set of detection boxes plus the additional boxes taken from the historical tracking boxes. The historical maximum is set to last calculated size of output boxes.

At step 414, a final pest count associated with the current image may be output based on the output boxes. This count may provide a more consistent measure of the pest population over time by leveraging both current detections and historical data.

At step 416, the historical maximum detection count may be updated if the number of output boxes exceeds the previous maximum. This step may help ensure the system maintains an accurate record of the highest observed pest count, which may be used in subsequent processing iterations.

The method 400 may be iteratively applied to a series of images captured over time, allowing for consistent and adaptive pest population tracking. By incorporating historical data through the use of tracking boxes and selectively adding boxes from previous detections, the method may provide more stable pest counts even in the face of temporary occlusions, lighting changes, or other factors that might cause a pest to be missed in a single image.

It is contemplated herein that different processing techniques may be applied to different regions of the pest capture area based on historical pest distribution patterns derived from the tracking boxes. For example, areas with historically high pest activity may be subjected to more sensitive detection settings or more aggressive incorporation of historical data.

Additionally, image enhancement techniques may be applied to the current image prior to performing object detection. These enhancement techniques may include contrast adjustment, noise reduction, or other processing steps, and may be selected based on historical detection performance in different image regions.

The method 400 may also include generating (e.g., displaying) visualizations of pest count trends over time based on the output boxes from multiple images. These visualizations may help users interpret pest population dynamics and identify potential infestations early.

Furthermore, the method 400 may incorporate an alert generation system that triggers notifications when the number of output boxes exceeds predefined thresholds or shows unusual growth patterns compared to historical data. This feature may provide timely warnings of potential pest control issues.

The adaptive pest detection and counting method 400 provides a robust approach to monitoring pest populations over time, balancing responsiveness to new detections with consistency based on historical data. By leveraging various types of boxes (detection, tracking, and output) and incorporating historical information, the method may provide more reliable and stable pest count data, even in challenging detection environments.

The disclosed subject matter provides for a deep learning-based object detection model that may be trained to recognize flies or other pests on pest-control capture apparatus 113 (e.g., a glue board). Upon detecting, the system (e.g., AI detection service 122 or function herein of system 101 or system 201) may quantify pests surpassing a predetermined threshold to ascertain the total number present on said glue board. A model may be trained using diversified datasets, which may include open-source insect repositories; datasets obtained through internet crawling, images of glue boards derived from pest traps; laboratory-acquired images using the hardware delineated in this disclosure; or field-sourced glue board images utilizing the aforementioned hardware.

Training of the model may be compromised by limited availability and quality of pest imagery. To mitigate challenges stemming from the extensivity of the datasets, data augmentation methods may be employed, which may involve: rotation of training visuals; image cropping techniques; or color grade enhancements. Through these augmentation measures, the system may ensure enriched training datasets, which may enhance visual feature extraction capabilities. Additionally, to address data inadequacies, data synthesis techniques may be integrated to construct training images for pest-control capture apparatuses by amalgamating pest images with those of unoccupied adhesive boards.

To optimize the object detection capabilities of the system and confront images with an abundance of objects, the disclosed system may introduce tailored tuning of model parameters to proficiently manage multiple objects simultaneously.

To address the problem of distortions in the raw imagery, given by the nature of the hardware posited herein, transformative measures may be applied to these images to realign them to a coherent physical plane. This may enhance feature detection of pests.

Traditional object detection algorithms only consider the current image, which poses a challenge when determining the number of (e.g., count) pests because pests may overlap with each other. By looking at just the current image, the system may under count or be unable to detect the present pests. To address such challenge, the system may implement a history based counting optimization, where a confidence score may be assigned to each detected pest based on the amount of time it has been consistently detected in history. From that, the system may generate the final count by merging the weighted historical count with the count of the current image.

Another approach to attacking the challenge of pests overlapping with each other on camera may be additional consideration of pest size. Beyond mere enumeration, the disclosed subject matter may offer size categorization for each detected pest. The system measures the bounding box dimensions of detected entities. To counteract potential image distortions stemming from wide-angle capture devices, the system may employ coordinate-based transformations restoring the bounding box to its true dimension. Size classifications may be ascertained from these rectified bounding boxes.

The disclosed subject matter may have the ability to gauge adhesive board or other pest-control capture apparatus occupancy percentages through remote surveillance. The occupancy rate may be determined by evaluating combined areas of bounding boxes relative to the comprehensive area of the pest-control capture apparatus.

In an example, the data collection may be through camera footage or fusion of other sensors, which may include temperature/humidity sensors, to gain more accurate environmental conditions. In another example, cleaning mechanisms may be implemented to clean the camera and additional sensors automatically. The disclosed subject matter may combine historical data, location, seasonal information, or weather data to predict patterns in pest movement or presence. The disclosed subject matter may generate increased characteristics that are descriptive of one or more pests. The characteristics currently include number of pests, but connected pest-control apparatuses 115 may utilize artificial intelligence to identify the species of pests captured by the pest-control capture apparatus 113. Although flies are referenced herein, it is contemplated that the disclosed subject matter be applicable to other insects or other pests. The disclosed subject matter may provide a more comprehensive understanding of infestations across a larger area by allowing direct sharing of data and insights between connected pest-control apparatuses 115 in a geographic location or network.

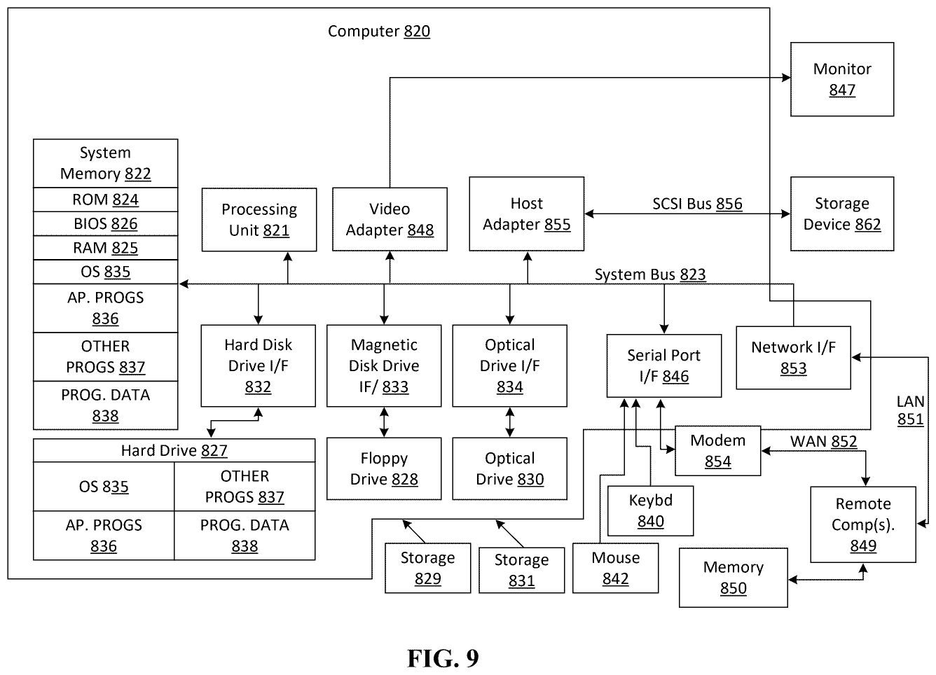

FIG. 9 and the following discussion are intended to provide a brief general description of a suitable computing environment in which the methods and systems disclosed herein and/or portions thereof may be implemented. Although not required, the methods and systems disclosed herein is described in the general context of computer-executable instructions, such as program modules, being executed by a computer, such as a client workstation, server, personal computer, or mobile computing device such as a smartphone. Generally, program modules include routines, programs, objects, components, data structures and the like that perform particular tasks or implement particular abstract data types. Moreover, it should be appreciated the methods and systems disclosed herein and/or portions thereof may be practiced with other computer system configurations, including hand-held devices, multi-processor systems, microprocessor-based or programmable consumer electronics, network PCs, minicomputers, mainframe computers and the like. The methods and systems disclosed herein may also be practiced in distributed computing environments where tasks are performed by remote processing devices that are linked through a communications network. In a distributed computing environment, program modules may be located in both local and remote memory storage devices.

FIG. 9 is a block diagram representing a general purpose computer system in which aspects of the methods and systems disclosed herein and/or portions thereof may be incorporated. As shown, the exemplary general purpose computing system includes a computer 820 or the like, including a processing unit 821, a system memory 822, and a system bus 823 that couples various system components including the system memory to the processing unit 821. The system bus 823 may be any of several types of bus structures including a memory bus or memory controller, a peripheral bus, and a local bus using any of a variety of bus architectures. The system memory includes read-only memory (ROM) 824 and random access memory (RAM) 825. A basic input/output system 826 (BIOS), containing the basic routines that help to transfer information between elements within the computer 820, such as during start-up, is stored in ROM 824.

The computer 820 may further include a hard disk drive 827 for reading from and writing to a hard disk (not shown), a magnetic disk drive 828 for reading from or writing to a removable magnetic disk 829, and an optical disk drive 830 for reading from or writing to a removable optical disk 831 such as a CD-ROM or other optical media. The hard disk drive 827, magnetic disk drive 828, and optical disk drive 830 are connected to the system bus 823 by a hard disk drive interface 832, a magnetic disk drive interface 833, and an optical drive interface 834, respectively. The drives and their associated computer-readable media provide non-volatile storage of computer readable instructions, data structures, program modules and other data for the computer 820. As described herein, computer-readable media is an article of manufacture and thus not a transient signal.

Although the exemplary environment described herein employs a hard disk, a removable magnetic disk 829, and a removable optical disk 831, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, magnetic disk 829, optical disk 831, ROM 824 or RAM 825, including an operating system 835, one or more application programs 836, other program modules 837 and program data 838. A user may enter commands and information into the computer 820 through input devices such as a keyboard 840 and pointing device 842. Other input devices (not shown) may include a microphone, joystick, game pad, satellite disk, scanner, or the like. These and other input devices are often connected to the processing unit 821 through a serial port interface 846 that is coupled to the system bus, but may be connected by other interfaces, such as a parallel port, game port, or universal serial bus (USB). A monitor 847 or other type of display device is also connected to the system bus 823 via an interface, such as a video adapter 848. In addition to the monitor 847, a computer may include other peripheral output devices (not shown), such as speakers and printers. The exemplary system of FIG. 9 also includes a host adapter 855, a Small Computer System Interface (SCSI) bus 856, and an external storage device 862 connected to the SCSI bus 856.

The computer 820 may operate in a networked environment using logical connections to one or more remote computers, such as a remote computer 849. The remote computer 849 may be a personal computer, a server, a router, a network PC, a peer device or other common network node, and may include many or all of the elements described herein relative to the computer 820, although only a memory storage device 850 has been illustrated in FIG. 9. The logical connections depicted in FIG. 9 include a local area network (LAN) 851 and a wide area network (WAN) 852. Such networking environments are commonplace in offices, enterprise-wide computer networks, intranets, and the Internet.

When used in a LAN networking environment, the computer 820 is connected to the LAN 851 through a network interface or adapter 853. When used in a WAN networking environment, the computer 820 may include a modem 854 or other means for establishing communications over the wide area network 852, such as the Internet. The modem 854, which may be internal or external, is connected to the system bus 823 via the serial port interface 846. In a networked environment, program modules depicted relative to the computer 820, or portions thereof, may be stored in the remote memory storage device. It will be appreciated that the network connections shown are exemplary and other means of establishing a communications link between the computers may be used.

Computer 820 may include a variety of computer readable storage media. Computer readable storage media can be any available media that can be accessed by computer 820 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media is physical structure that is not a signal per se. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 820. Combinations of any of the above should also be included within the scope of computer readable media that may be used to store source code for implementing the methods and systems described herein. Any combination of the features or elements disclosed herein may be used in one or more examples. The terms machine learning (ML), deep learning, or artificial intelligence (AI) may be used interchangeably herein.

Additionally, contrary to conventional computing systems that use central processing units (CPUs), in some examples the disclosed connected pest-control system(s) may primarily use graphics processing units (GPUs), field-programmable gate arrays (FPGAs), or application-specific integrated circuits (ASICs), which may be referenced herein as AI chips, for executing the disclosed methods. Unlike CPUs, AI chips may have optimized design features that may dramatically accelerate the identical, predictable, independent calculations required by AI applications or AI algorithms. These algorithms may include executing a large number of calculations in parallel rather than sequentially, as in CPUs; calculating numbers with low precision in a way that successfully implements AI applications or AI algorithms but reduces the number of transistors needed for the same calculation(s); speeding up memory access by, for example, storing an entire AI application or AI algorithm in a single AI chip; or using programming languages built specifically to efficiently translate AI computer code for execution on an AI chip.

The object detection model exercised by AI detection service 122 analyzes one singular frame, FIG. 3, in smaller frames (e.g., 156), which is described in more detail in FIG. 4. This image pre-processing is an example of the AI chip's programming to create a more detailed calculation and produce more accurate results. Different types of AI chips are useful for different tasks. GPUs may be used for initially developing and refining AI applications or AI algorithms; this process is known as “training.” FPGAs may be used to apply trained AI applications or AI algorithms to real-world data inputs; this is often called “inference.” ASICs may be designed for either training or inference. The AI detection service 122 may exercise a model trained using diversified datasets, which may encompass open-source insect repositories, images of adhesive boards derived from fly traps, lab-acquired adhesive board images, or field-sourced adhesive board images utilizing the hardware of connected pest-control apparatuses 115.

Methods for detecting and determining the number of objects (e.g., pests) are disclosed herein. A method may provide for receiving an image of a capture area from an image capture device; partitioning the received image into a plurality of grid cells; for each grid cell of the plurality of grid cells: analyzing characteristics of the grid cell, selecting processing techniques based on the analyzed characteristics, applying local image transformations to the grid cell, and detecting and counting pests within the grid cell using the selected processing techniques; aggregating pest detection and counting results from the plurality of grid cells; and outputting aggregated results. The method may further include comparing the received image to a previously received image to identify cells with changes; and applying differencing algorithms to the identified cells. The method may also include dynamically adjusting size or shape of the grid cells based on pest distribution patterns in the received image. Selecting processing techniques may include choosing different heuristics or optimization algorithms for different grid cells based on their analyzed characteristics. The method may further include applying multi-scale processing by analyzing the partitioned image at multiple levels of granularity. Although an example is provided associated with a pest-control capture apparatus, it is contemplated herein that this may be broadly applicable to any capture area and targeted objects within. A targeted object may vary and may include non-living objects (e.g., stones in a creek or types of suitcases on a conveyor) or living objects (e.g., fish in the creek or rodents on a glue board). Pest used as an example of any object (e.g., targeted object). All combinations (including the removal or addition of steps) in this paragraph and previous paragraphs are contemplated in a manner that is consistent with the other portions of the detailed description.

The method may also include displaying the aggregated results on a user interface; receiving user feedback via the user interface; and adjusting processing parameters based on the user feedback. The method may further include transmitting the aggregated results to a remote monitoring station via a communication module. Detecting and counting pests may include applying machine learning models trained on diverse pest images to identify and count pests within each grid cell. The method may also include tracking pest activity patterns over time by comparing aggregated results from multiple images captured at different times. Applying local image transformations may include adjusting contrast, reducing noise, or enhancing image quality specifically for each grid cell based on its characteristics. All combinations (including the removal or addition of steps) in this paragraph and previous paragraphs are contemplated in a manner that is consistent with the other portions of the detailed description.

Methods, systems, or apparatus for detecting and determining the number of objects (e.g., pests) are disclosed herein. A method, system, or apparatus may provide for receiving a first image associated with a capture area (e.g., pest-control capture apparatus); partitioning the first image into two or more grid cells; analyzing first characteristics of a first grid cell of the two or more grid cells; determining first processing techniques based on the analyzed first characteristics; generating a transformed first grid cell based on applying a first local image transformation to the first grid cell; detecting one or more pests within the transformed first grid cell using the determined first processing techniques; and counting (e.g., determining the number of) pests within the transformed first grid cell; analyzing second characteristics of a second grid cell of the two or more grid cells; determining second processing techniques based on the analyzed second characteristics; generating a transformed second grid cell based on applying a second local image transformation to the second grid cell; detecting one or more pests within the transformed second grid cell using the determined second processing techniques; and counting pests within the transformed second grid cell; generating an aggregate result based on the counting of pests within the transformed first grid cell and the counting of pests within the transformed second grid cell; and transmit the aggregated result. Partitioning the captured image may comprise adjusting size or shape of the grid cells based on pest distribution patterns in the received first image or the received second image. Separate images may be generated for each transformed grid cell. The determining of the first processing techniques may comprise selecting different heuristics for different grid cells of the first grid cell and the second grid cell. All combinations (including the removal or addition of steps) in this paragraph and the above paragraphs are contemplated in a manner that is consistent with the other portions of the detailed description.

The determining of the first processing techniques may comprise selecting different heuristics for different grid cells of the first grid cell and the second grid cell based on the respective different analyzed characteristics of the first grid cell and the second grid cell. The method may further include receiving user feedback via a user interface; and adjusting, based on the user feedback, processing parameters associated with analyzing two or more grid cells. The method may further include tracking pest activity patterns over time by comparing aggregated results from multiple images captured at different times. The method may further include applying random parameters and testing multiple candidate transformations for grid cells with complex pest distributions. All combinations (including the removal or addition of steps) in this paragraph and the above paragraphs are contemplated in a manner that is consistent with the other portions of the detailed description.

Methods, systems, or apparatus for automated object (e.g., pest) detection and counting are disclosed herein. A method, system, or apparatus provides for receiving an image of a capture area; generating one or more current detection boxes associated with pests based on performing object detection on the image; determining output boxes based on comparing the one or more current detection boxes with historical detection boxes; generating the output boxes; and transmitting a pest count based on the output boxes. The output boxes may be equivalent to an amount of one or more current detection boxes based on the amount of the one or more current detection boxes being greater than an amount of historical tracking boxes. The output boxes may be equal to an amount of one or more current detection boxes and an amount of additional boxes based on the amount of the one or more current detection boxes being less than an amount of historical tracking boxes. Comparing the one or more current detection boxes with historical detection boxes may include matching current detection boxes with historical detection boxes based on spatial overlap or appearance similarity. All combinations (including the removal or addition of steps) in this paragraph and the above paragraphs are contemplated in a manner that is consistent with the other portions of the detailed description.

Based on a historical object distribution pattern derived from the historical detection boxes, the method may use a first processing technique for a first region of the capture area and a second processing technique for a second region of the capture area. The first processing technique or the second processing technique comprises threshold-based segmentation of cells associated with a contrast, edge-based detection, or color-based segmentation of cells. The method may further include displaying a visualization of pest count trends over time based on the output boxes associated with multiple images. All combinations (including the removal or addition of steps) in this paragraph and the above paragraphs are contemplated in a manner that is consistent with the other portions of the detailed description.

What is claimed:

1. A method comprising:
receiving an image of a capture area;
generating one or more current detection boxes associated with objects based on performing object detection on the image;
determining output boxes based on comparing the one or more current detection boxes with historical detection boxes;
generating the output boxes; and
transmitting an object count based on the output boxes.

2. The method of claim 1, wherein the output boxes are equivalent to an amount of one or more current detection boxes based on the amount of the one or more current detection boxes being greater than an amount of historical tracking boxes.

3. The method of claim 1, wherein the output boxes are equal to an amount of one or more current detection boxes and an amount of additional boxes based on the amount of the one or more current detection boxes being less than an amount of historical tracking boxes.

4. The method of claim 1, wherein comparing the one or more current detection boxes with historical detection boxes comprises matching current detection boxes with historical detection boxes based on spatial overlap or appearance similarity.

5. The method of claim 1, further comprising based on a historical object distribution pattern derived from the historical detection boxes:
using a first processing technique for a first region of the capture area; and
using a second processing technique for a second region of the capture area.

6. The method of claim 5, wherein the first processing technique or the second processing technique comprises threshold-based segmentation of cells associated with a contrast, edge-based detection, or color-based segmentation of cells.

7. The method of claim 1, further comprising displaying a visualization of object count trends over time based on the output boxes associated with multiple images.

8. A device comprising:
a processor; and
a memory coupled with the processor, the memory storing executable instructions that when executed by the processor cause the processor to effectuate operations to:
receive an image of a capture area;
generate one or more current detection boxes associated with objects based on performing object detection on the image;
determine output boxes based on comparing the one or more current detection boxes with historical detection boxes;
generate the output boxes; and
transmit an object count based on the output boxes.

9. The device of claim 8, wherein the output boxes are equivalent to an amount of one or more current detection boxes based on the amount of the one or more current detection boxes being greater than an amount of historical tracking boxes.

10. The device of claim 8, wherein the output boxes are equal to an amount of one or more current detection boxes and an amount of additional boxes based on the amount of the one or more current detection boxes being less than an amount of historical tracking boxes.

11. The device of claim 8, wherein the one or more processors, when comparing the one or more current detection boxes with historical detection boxes comprises matching current detection boxes with historical detection boxes based on spatial overlap or appearance similarity.

12. The device of claim 8, further operations comprise:
based on a historical object distribution pattern derived from the historical detection boxes:
use a first processing technique for a first region of the capture area; and
use a second processing technique for a second region of the capture area.

13. The device of claim 12, wherein the one or more processors, when the first processing technique or the second processing technique, are configured to threshold-based segmentation of cells associated with a contrast, edge-based detection, or color-based segmentation of cells.

14. The device of claim 8, wherein the one or more processors are further configured to:
display a visualization of object count trends over time based on the output boxes associated with multiple images.

15. A non-transitory computer readable storage medium storing computer executable instructions that when executed by a computing device cause the computing device to effectuate operations comprising:
receive an image of a capture area;
generate one or more current detection boxes associated with objects based on performing object detection on the image;
determine output boxes based on comparing the one or more current detection boxes with historical detection boxes;
generate the output boxes; and
transmit an object count based on the output boxes.

16. The non-transitory computer-readable medium of claim 15, wherein the output boxes are equivalent to an amount of one or more current detection boxes based on the amount of the one or more current detection boxes being greater than an amount of historical tracking boxes.

17. The non-transitory computer-readable medium of claim 15, wherein the output boxes are equal to an amount of one or more current detection boxes and an amount of additional boxes based on the amount of the one or more current detection boxes being less than an amount of historical tracking boxes.

18. The non-transitory computer-readable medium of claim 15, wherein the one or more instructions that cause the computing device to compare the one or more current detection boxes with historical detection boxes comprises matching current detection boxes with historical detection boxes based on spatial overlap or appearance similarity.

19. The non-transitory computer-readable medium of claim 15, the operations further comprising:
based on a historical object distribution pattern derived from the historical detection boxes:
use a first processing technique for a first region of the capture area; and
use a second processing technique for a second region of the capture area.

20. The non-transitory computer-readable medium of claim 19, wherein the one or more instructions that cause the computing device to the first process technique or the second processing technique, cause the device to threshold-based segmentation of cells associated with a contrast, edge-based detection, or color-based segmentation of cells.
